(19) United States
(12) Patent Application Publication
(10) Pub. No.: US 2017/0214542 A1
(43) Pub. Date: Jul. 27, 2017

(54) A METHOD FOR COMMISSIONING A NETWORK NODE

(71) Applicant: PHILIPS LIGHTING HOLDING B.V., EINDHOVEN (NL)

(72) Inventor: Bozena ERDMANN, EINDHOVEN (NL)

(73) Assignee: Philips Lighting Holding B.V., Eindhoven (NL)

(21) Appl. No.: 15/324,715

(22) PCT Filed: Jul. 6, 2015
(86) PCT No.: PCT/EP2015/065403

§ 371 Date: Jan. 8, 2017

(30) Foreign Application Priority Data
Jul. 8, 2014 (EP) 14176101.5

(51) Int. Cl. H04L 12/28; H04W 72/04

(52) U.S. Cl. CPC H04L 12/2816; H04W 72/0453; H04L 12/282; H04L 12/2807; H04W 84/18

(57) ABSTRACT

The present invention relates to a method for commissioning a resource-restricted device to a network, to link said resource-restricted device to a network sink, the method comprising the steps of receiving at the network sink a commissioning initiation message from the resource-restricted device for initiating a commissioning in accordance with a first commissioning process to link said resource-restricted device to the network sink, if the first commissioning process cannot be supported by the network sink, the network sink triggering a feedback including actuation of an actuator connected to the network for prompting a user to select a fallback commissioning process via a commissioning process selection at the re-source-restricted device.

### FIELD OF THE INVENTION

The present invention relates to the field of wireless mesh networks, and devices configured therefor. This invention relates more specifically to the commissioning of a device, for example a ZigBee Green Power Device in a network, for example a ZigBee network.

### BACKGROUND OF THE INVENTION

Along with the current trend for wireless communication networks for controlling actuators, in particular in home automation, it has been developed devices with very low power consumption for controlling these actuators. Such devices may be harvesting the energy for its operation from their environment. A typical example of such device is an energy harvesting wireless switch which uses the mechanical energy harvested from the user actuating the rocker of the switch for transmitting commands towards the network or for receiving messages from the network. Another example of such device may be a light sensor, harvesting its energy from a photocell, sending commands to the networks for example depending on the luminance level.

These devices can be defined as resource-restricted device since their operation depends on the quantity of energy they can harvest in their environment. These devices can transmit only when a sufficient energy amount of energy has been collected from the environment. Moreover, in some variants, like in the case of ZigBee Green Power Devices (GPD), these devices can only receive a message during a short reception window after a transmission period. In the case of an energy-harvesting switch, this switch can only transmit when the user has actuated the rocker, and then may be able to receive after. In case of an energy rich resource-restricted device, i.e. a harvesting device having a large or continuous supply of energy, like a light sensor powered by a photo cell, it can transmit periodically or continuously for some time. However, if the light is below a threshold, no energy can be harvested anymore, and the device cannot communicate anymore on the network. Because of these unscheduled transmission/reception windows which cannot be controlled, the operation of these devices in network requires some measures.

Regarding the commissioning, several commissioning processes can be supported by these devices, however, the various network entities may not all be able to operate with all of these processes, but only one or the other. Indeed, in view of the limitations of the resource-restricted device, during the commissioning of such devices, the network entities are carrying out most of the actions of the commissioning of such resource-restricted device, and typically the most complicated part. Besides, the network entities need also to be compatible with the other processes of the network, and may also include a large application code, although those network devices can be of low complexity for example a light bulb. Therefore, it may not be possible for such a low-cost device to have sufficient memory to store the code for all the possible commissioning processes they can encounter from the resource-restricted devices, especially if the functionality required by a particular commissioning process is only used during commissioning and otherwise not required for the operation and/or application of those network devices. Further, the specification of ZigBee Green Power may in the future may in the future make some of the Green Power-specified commissioning processes optional for the network devices

Moreover, on such resource-restricted devices, the user-interface is usually inexistent or very limited which renders the commissioning of such devices sometimes cumbersome for the user. Little or no feedback is given to the user to guide him/her in the process of commissioning the resource-restricted device to the network, and little means is provided for the user to perform user actions.

### SUMMARY OF THE INVENTION

It is an object of the invention to alleviate the above-identified problems.

It is another object of the invention to propose a method for commissioning a resource-restricted device which improves the experience for the user.

It is still another object of the invention to render the commissioning of such devices more efficient even if some commissioning processes are not supported by some network nodes.

To this end, in accordance with a first aspect of the invention, it is proposed a method for commissioning a resource restricted device to a network, to link said resource-restricted device to a network sink,

the method comprising the steps of
receiving at the network sink a commissioning initiation message from the resource-restricted device for initiating a commissioning in accordance with a first commissioning process to link said resource-restricted device to the network sink,
if the first commissioning process cannot be supported by the network sink, the network sink triggering a feedback including actuation of an actuator connected to said network for prompting a user to select a fallback commissioning process via a commissioning process selection at the resource-restricted device.

Therefore, in case the resource-restricted device cannot be commissioned by way of the commissioning process it had selected, the network sink can trigger some feedback which is given by the network itself and not by the resource-restricted device. Indeed, some of these restricted devices may not be able to receive a message indicative of the failure of the first commissioning process; also, the network, not supporting the process, may not be able to provide the appropriate message indicative of the failure of the first commissioning process. Therefore, the network by actuating an actuator of the network can provide the feedback to the user. The user is thus prompted to take some action so as to select a different commissioning process.

It is to be noted that in the meaning of the invention, the fact that the first commissioning process cannot be supported can be for different reasons. First, in case there is no support of the first commissioning process on the network sink. For example, the network sink is only able to do one or two of the several possible commissioning processes. The reason of this limitation can be for example because of shortage of memory on the network sink. Indeed, for such devices, the memory size required to store all the commissioning processes for the resource-restricted devices may be incompatible with the total code size required to be present on such network sink, incl. e.g. the network stack and the application code required to properly operate the actuator; it may also be incompatible due to a limitation on cost, physical size or complexity of such network sinks, e.g. if embedded into low-cost, size limited everyday objects, such as e.g. light bulbs.

Besides, the first commissioning process may not be supported because the communication conditions do not enable this commissioning process. For example, there may be no reliable communication for supporting the first commissioning process. Indeed, it may require a good communication channel with low interference to avoid loss of packets, especially in the case if bidirectional communication is involved.

Eventually, as will be explained in more details in the description of the embodiments of the invention, the communication between the resource-restricted device and the network sink may be done via an intermediary node, e.g. a proxy node; at commissioning time it is required if both the resource-restricted device and the network sink are already installed at their desired locations and are out of each other's radio range, especially if moving either into the range of the other is impossible or undesired. If the intermediary proxy node does not support the first commissioning process, for example because it cannot handle the bidirectional communication with the resource-restricted device, it is considered that the first commissioning process cannot be supported at the network sink.

The commissioning initiation message is originated from the resource-restricted device to allow it to join the network, incl. bootstrapping of security, and be linked to one or more network sinks. Once it has been commissioned, the resource-restricted device will be able to send commands to the network sinks it is linked to so that the resource-restricted device can operate these, e.g. switch ON/OFF, dim the lights of the sinks, report sensed parameter change (e.g. illumination, temperature, presence, humidity, opening/closing action, etc.), to trigger appropriate reaction on the sink, etc. In the particular example of bidirectional commissioning according to Green Power specification, the commissioning initiation message is the first message of the 5-way handshake, i.e. the GPD Channel Request command.

This commissioning initiation message in the sense of this invention can be either received directly from the resource-restricted device, or relayed by an intermediary node (a proxy node). The intermediary node can tunnel the original message in a relayed message which may encapsulate the payload of the message transmitted by the resource-restricted device or may be indicative of the contents of such message. The commissioning initiation message does not necessarily enable the commissioning process on the network sink. Indeed, it can be beneficial for the system security, if the commissioning process is enabled separately on the network sink, e.g. by a user action on the network sink itself or a command from a (trusted) network node; prior to engaging in the commissioning exchange with the resource-restricted device or at least as a precondition for establishing control relationship (linking) and/or exchanging security credentials with the resource-restricted device.

In an embodiment of the first aspect of the invention, the step of the network sink triggering a feedback comprises at least one of the following:
causing at least one network node to switch on a luminaire or a LED with a predefined setting;
causing at least one network node to emit an acoustic signal or a vibration;
causing a Graphic User Interface of a network node to inform the user to select a fallback commissioning process. Thus, a feedback can be to switch on a luminaire or a LED with a particular color setting or blinking.

In a particular example, said network sink drives a sink actuator, and the step of triggering a feedback includes actuation of said sink actuator in accordance with a predefined setting. Indeed, the network sink can be driving a luminaire, and the luminaire which is switched on to indicate the feedback is the luminaire controlled by the sink. Alternatively, the network sink can have at least one LED, e.g. for status indication or another information for the user, and this LED can be driven to provide the feedback.

However, in another example of this first example, which could nevertheless be combined with the previous example, the step of triggering a feedback comprises the step of selecting at least one node in the vicinity of the resource-restricted device and triggering the actuator of said selected node. Thus, by selecting a luminaire in the vicinity of the resource-restricted device, it can help the user to identify the issue in case a plurality of resource-restricted devices are commissioned at the same time or if the network sink being commissioned with the resource-restricted device is too far away from the resource-restricted device and/or the user to reliably provide feedback or the network sink being commissioned with the resource-restricted device cannot provide feedback, e.g. because it is hidden behind a wall, ceiling, etc.

In another embodiment of the invention which can be combined with the previous embodiment, the step of receiving a commissioning initiation message comprises detecting that the commissioning has been initiated by the resource-restricted device in accordance with a first commissioning process, said detection including at least one of the following:
determining that the commissioning initiation message includes command identifier indicative of a channel request in accordance with the first commissioning process;
determining a frame type indicative of maintenance frame used by the resource-restricted device to initiate the first commissioning process;
determining that a reception window indicator value, indicative of a reception window during which the resource-restricted device receiver is activated, is of a predetermined value;
determining that the initiation message carries a request for electing a proxy node for interfacing the resource-restricted device with the rest of the network.

In still another embodiment of the invention which can be combined with the previous embodiments, when initiating the first commissioning process, the resource-restricted device transmits an initiation message on a set of channels comprising at least one channel of a sequence list of channels, and remain in a receiving state for a receive window duration on a receiving channel corresponding to the set of channels before switching after a predetermined time duration to the next set of channels for transmission on the at least one channel of the next set in order to find an operational channel of the network, wherein the resource-restricted device deduces from the time instant at which the user selects a fallback method an indication of the operational radio channel of the network. Thus, the resource-restricted device does not restart from zero when starting the fallback commissioning process. It can already deduce some information on which operational channel the network is operating on, thus shortening the time required for the fallback commissioning process to be processed.

To give sufficient accuracy to the timing from the user, and thus reducing still the amount of time required to find the operational channel, the time duration is of an order of magnitude being similar to an order of magnitude of a reaction time of a human being, and the resource-restricted device deduces from the time instant at which the user selects a fallback method that the operational radio channel of the network is included in the set of channels of the latest transmission. Thus, this variant ensures that the user has carried out some action in response to the feedback during the same set of channels that triggered the feedback. Typically, it is believed that this order of magnitude is around 2 seconds, to take into account that the user sees the feedback signal and carries out some action on the resource-restricted device.

In another variant, the time duration is of an order of magnitude being lower than an order of magnitude of a reaction time of a human being, and thus the resource-restricted device can deduce from the time instant that the operational radio channel is included in a subset of channels of the sequence list, and the resource-restricted device starts the fallback commissioning process based on said subset of channels, wherein the subset of channels consists of at least one set of channels.

If the time duration is shorter, the resource-restricted is likely to have transmitted several sets of channels in the typical reaction time of a human being, i.e. between the transmission on set of channels that triggered the feedback and the time instant, and thus, the operational channel should be included in these several sets of channels. Thus the further search in the fallback commissioning process can be reduced to these several sets of channels. The resource-restricted device may be able to estimate the number of channel sets corresponding to the reaction time of the human being, and limited the search to those. Otherwise, the resource-restricted device may be able to reduce the further search to all channel sets transmitted on so far.

In an example, the resource-restricted device can resume the channels search from one of the channels recently transmitted on when the user triggers the selection of the fallback commissioning process. Indeed, in this example, the time duration is of an order of magnitude being lower than an order of magnitude of a reaction time of a human being, and the resource-restricted device deduces from the time instant a radio channel from the list, the resource-restricted device thus resuming the channel search in the fallback commissioning process from said radio channel.

In a further example of the previous variants, the channel search can be resumed in reverse order for the fallback commissioning process.

In another example of these variants, the first commissioning process comprises the resource-restricted device changing the set size and/or the time duration depending on the feedback or the progress of the first commissioning process. Thus, this adaptation enables keeping the speed to the first commissioning process if supported by the network sink (especially if this is the bidirectional commissioning process and it is possible to be accomplished with system reaction times much lower than the human reaction times) and/or making the initial search slower to allow for human fallback indication in case first commissioning process is not supported by the network sink, and speeding up again as soon as support is detected.

In another embodiment, the fallback commissioning process is selected by the network from a set of a plurality of commissioning processes, and wherein the feedback is indicative of the fallback commissioning process selected from the set. Thus, this guarantees that the fallback commissioning process will be supported by the network sink. Moreover, the feedback can be indicative of the operational channel of the network. The user can then input the operational channel to the resource-restricted device, if the resource-restricted device does support such input, enabling to limit the time required in the fallback commissioning process.

In accordance with a second aspect of the invention, it is proposed a network sink adapted for operating in a network,
the network sink comprising a receiver adapted for receiving a commissioning message from a resource-restricted device in order to link said resource-restricted device to the network sink,
the network sink being arranged to determine from the commissioning message that a first commissioning process was initiated,
the network sink being arranged to determine if the first commissioning process can be supported, and wherein the network sink is adapted to trigger a feedback including actuation of an actuator connected to the network for prompting a user to select a fallback commissioning process via a commissioning process selection at the resource-restricted device upon determination that the first commissioning process cannot be supported.

In accordance with a third aspect of the invention, it is proposed a network device for communicating in a network,

the network device being arranged to initiate a first commissioning process to be linked with a network sink,
the network device comprising a transceiver and the network device being arranged to control its transceiver for transmitting an initiation message in accordance with the first commissioning process on a set of channels comprising at least one channel of a sequence list of channels, and to remain in a receiving state for a receive window duration on a receiving channel corresponding to the set of channels before switching after a predetermined time duration to the next set of channels for transmission on the at least one channel of the next set of channels,
wherein the network device is arranged to start a fallback commissioning process upon reception of a fallback trigger, and wherein the network device deduces an indication of the operational radio channel of the network from the time instant at which the fallback trigger is received.

In accordance with a fourth aspect of the invention, it is proposed a method for commissioning a network device to a network sink in a network,

comprising steps of

(a) the network device initiating a first commissioning process, wherein step (a) includes
the network device searching an operational channel of the network, whereby
   the network device transmits an initiation message on a set of channels comprising at least one channel of a sequence list of channels, and
   the network device remains in a receiving state for a receive window duration on a receiving channel corresponding to the set of channels before switching after a predetermined time duration to the next set of channels for transmission on the at least one channel of the next set of channels,

(b) receiving a fallback trigger requesting the network device to select a fallback commissioning process, wherein the network device derives the operational radio channel of the network from the received fallback trigger.

In variants of the fourth aspect of the invention, the step of the resource-restricted device deriving the operational channel can include one of
the network device deduces an indication of the operational radio channel of the network from the time instant at which the fallback trigger is received, and wherein the fallback trigger is a feedback selection input from a user; or
the network device extracts an index indicative of the operational channel from the fallback trigger, which is a received feedback message, or
the network device deduces an indication of the operational radio channel of the network from the time instant at which the fallback trigger, which is a feedback message, is received.

Thanks to the third and fourth aspects of the invention, the network device can derive from the fallback trigger two pieces of information: first, the first commissioning process has failed because for example of lack of support at the network sink; second, from this failure of the first commissioning process, the operational channel can still be determined, either directly or from the timing of the fallback trigger. This means that the fallback commissioning process can complete faster than normally as some information regarding the operational channel has already been obtained. Thus, in addition to presenting an interoperable solution, this provides a more robust and easy-to-use commissioning method while keeping this commissioning efficient. It is to be noted that while these aspects of the invention are beneficial for resource-restricted devices, these aspects, in particular the third and fourth aspects, can also apply to any network device trying to commission to a network supporting a plurality of commissioning processes and that can be operative on a plurality of channels.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 is a block diagram representing a network in which the invention is implemented;

FIGS. 2A and 2B are flowcharts representing an illustrative commissioning process;

FIG. 3 is a flowchart showing a method in accordance with a first embodiment of the invention;

FIG. 4 is a flowchart showing a method in accordance with a second embodiment of the invention;

FIG. 5 is a block diagram representing a network sink in accordance with an embodiment of the invention;

FIG. 6 is a block diagram representing a network device, for example, a resource-restricted device in accordance with another embodiment of the invention.

### DETAILED DESCRIPTION OF THE INVENTION

The present invention relates to a method for commissioning a resource-restricted device, for example in a low-cost low complexity network.

The present invention is more especially dedicated to wireless mesh networks, and as an example can be implemented in a ZigBee network having some of the network nodes being compatible to ZigBee Green Power Specifications. Throughout the description, the Green Power Device will be used as an exemplary realization/embodiment of the resource-restricted device; however, the invention is not restricted to GPDs.

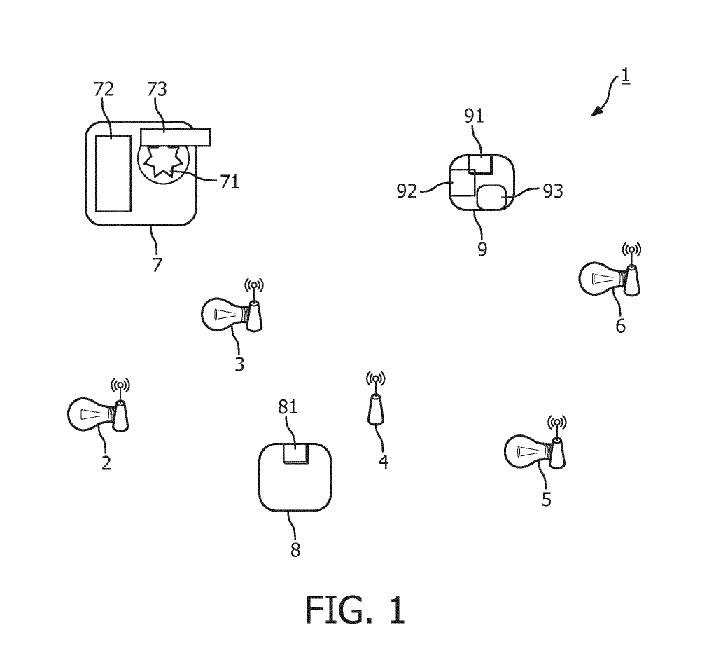

In the exemplary network of FIG. 1, a number of network nodes 2, 3, 4, 5 and 6 form a network, for example a mesh network. Moreover, this network comprises resource-restricted devices 7, 8 and 9. This network may be a ZigBee network, where network nodes 2, 3, 4, 5 and 6 are normal ZigBee nodes, at least some of which are capable of communication with the Green Power Devices, and the resource-restricted devices 7, 8 and 9 are Green Power Devices. Alternatively, this network may be any other mesh network based on the IEEE802.15.4 radio, where network nodes 2, 3, 4, 5 and 6 are nodes according to that network protocol at least some of which are capable of communication with the Green Power Devices, and the resource-restricted devices 7, 8 and 9 are Green Power Devices.

The Green Power feature of the ZigBee standard allows for natively integrating into the ZigBee network 1 devices which are yet more energy-efficient than the ZigBee End Devices (ZED) or ZigBee Routers 2, 3, 4 and 5. The Green Power specification aims to cover a wide variety of resource-restricted devices (or Green Power Devices (GPD)):
from very energy-restricted devices, like e.g. the switch 7 harvesting the energy of user operation by means of its harvester 71, possibly only capable of transmission after the user action. This action is carried out by the radio module 72 which is supplied with power by the harvester 71 upon actuation of a user interface means 73 by a user;
through moderately energy-restricted devices (e.g. devices powered via a solar cell 81 or capable of harvesting more energy from being operated), possibly capable of opening short reception window after the transmission,
up to “energy-rich” Green Power Devices (GPD), for example resource-restricted device 9, (e.g. powered by a battery or energy harvester and/or storage allowing for higher and/or more frequent energy inflow, e.g. bigger solar cell, harvesting electro-magnetic energy of current flow, harvesting energy of other medium flow, harvesting thermal differences, etc.), allowing the device to extend the battery lifetime (or allowing the battery lifetime to match with the intended product lifetime) and/or decrease the cost of the connectivity interface, thanks to a stack leaner than that of a ZED. In this example, the resource-restricted device 9 is a light sensor comprising a solar cell 91 which is supplying power to the radio module 92 and to a battery or capacitor 93.

Due to their resource-restricted nature, the GPD usually come with no (other than those required by their primary functionality, e.g. enabling user on/off or level control action) or only simple user interface means, e.g. a button to enable commissioning mode. Typically, local feedback in form of screens or even LEDs or buzzers is not available on this type of devices, due to the lack of energy required to provide this feedback, due to the restricted usability and understandability of such feedback to the user because of the very limited user interaction means and/or to keep their complexity and cost as low as possible.

In order to address this broad spectrum of device needs and capabilities, the Green Power specification is like a menu, allowing the GPD vendors to pick the options that best meet the requirements of their device. The burden of interoperability, i.e. supporting all those different options, is shifted to the infrastructure side, i.e. to the devices controlled by the GPD (called Green Power Sinks, or sinks for short) and/or the devices forwarding on behalf of the GPD (called the Green Power Proxies, or proxies for short).

Following this menu approach, the Green Power specification defines three commissioning processes for the GPD (see sec. A.3.9.1, page 153-161 of 095499r24). The term commissioning in GP specification is meant to cover at least the following tasks: (i) bringing the GPD on the operational channel of the network, (ii) agreeing on security use, if possible, and credentials, (iii) establishment of control relationship between the GPD and the sinks, based on matching application functionality. Of those tasks, the bringing of the GPD on the operational channel of the network is the most critical one, as it allows the further message exchange between the resource-restricted device and the network. Indeed, ZigBee networks can work on any of the 16 channels in the 2.4 GHz band of the IEEE802.15.4-2003; the resource-restricted devices supports only limited user interaction means, both input and output, as mentioned above, and—typically—the user lacks the knowledge of the operational channel used by the network and/or lack of means and/or knowledge to determine it. Thus, bringing of the GPD on the operational channel of the network is important differentiating factor of the different commissioning processes, likely also to heavily influence the user's commissioning experience, and thus the focus of the following methods.

One of the possible commissioning processes is the auto-commissioning process which uses any regular GPD data frame (e.g. On or Off); the Auto-Commissioning flag set to 0b1 indicates that the GPD is not capable of any more advanced commissioning operation, and thus commissioning shall be done based on the data frame. This method has the advantage of being most lean for the GPD; on the other hand, the application functionality matching it provides is very limited (based on the single command), and establishment of security keys is impossible; if GPD is configured for operation on a single channel only, obviously, it may not be possible to add it to a network operating on another channel. Usually, an auto-commissioning GPD is configured for operation on a single channel or provide simple means for the GPD to toggle through the candidate channels, e.g. DIP switches or repetitive commissioning action of the user; once the GPD transmits on the operational channel of the network, success feedback is provided perceivably to the user by the network sink, indicating commissioning is done.

A further commissioning is the unidirectional commissioning process which requires the GPD to implement a GPD Commissioning command, which can transfer data assisting functionality matching on the sink (at the minimum, the DeviceID, and optionally also further application information, incl. list of supported commands and list of supported ZCL clusters, manufacturer identified and model number, as specified in sec. A.4.2.1, page 211-215, of the GP v1.0.1 specification, ZigBee document 14-0093r04) and security capabilities, incl. the security key provided by the OOB. For channel configuration, as for auto-commissioning GPD, a form of channel toggling with user-perceivable success feedback is used.

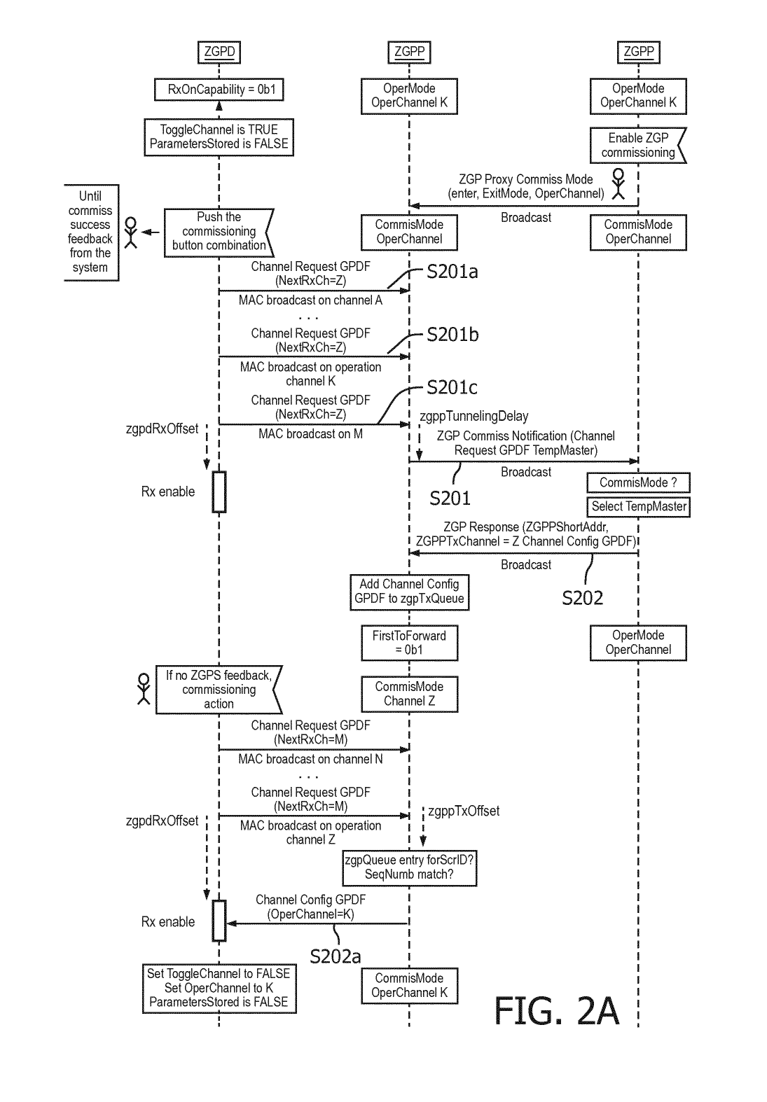

The bidirectional commissioning process is another commissioning process and is illustrated on FIGS. 2A and 2B. This commissioning process is based on a 5-way handshake. In the network 1 of FIG. 1, the resource-restricted device 8 needs to be commissioned to be associated to the network sink 6. However, since the resource-restricted device 8 is placed out of range of the network sink 6, the communication between this resource-restricted device 8 and the network sink 6 needs to be relayed by a proxy node, here the network node 1. This relaying is done by tunneling the messages originated from the resource-restricted device 8, so that the tunneled messages can be routed to the network sink 6.

When the user performs a commissioning action on the resource-restricted device 8 (e.g. presses a combination of buttons) at step S200, this triggers the commissioning of said resource-restricted device 8 according to the first commissioning process, being the bidirectional commissioning process of the Green Power specification. The resource-restricted device then looks for the operational channel of the network. To do so, it transmits a Green Power Device Frame of type Maintenance frame, carrying a GPD Channel Request command on a first set of channels (a) at S201a, (b) at S201b, (c) at S201c and then switches to a receiving channel to await a reply. If the operational channel was one of channels (a), (b) or (c), the proxy node 1 receives the Green Power Device Frame carrying the GPD Channel Request and tunnels it to the network sink 6 in the GP Commissioning Notification at step S201.

The network sink 6 which can, in this example support this commissioning process replies by sending a GPD Channel Configuration command containing the operational channel to the proxy node 1 at S202, tunneled in GP Response message. The proxy node buffers this message until the next reception window of the resource-restricted device 8 to forward the reply from the network sink 6 at step S202a as a Green Power Device Frame of type Maintenance frame, carrying the GPD Channel Configuration command with the operational channel. Thus, the first two messages at steps S201a and S202a configure the operational channel on the resource-restricted device 8.

Then, when the user performs a commissioning action anew on the resource-restricted device 8, the resource-restricted device transmits on the operational channel a Green Power Device Frame of type Data frame, carrying GPD Commissioning command at Step S203a forwarded by the proxy node at step S203. The Commissioning Reply command is replied at step S204a by the network sink 6 via the proxy node 1 with the GPD Commissioning Reply command. These two messages allow for exchange of security credentials and application information. Eventually, upon a commissioning action by the user, the resource-restricted device (GPD) 7 transmits the fifth message at S205a indicative confirming the successful commissioning and allowing for verification of the established security credentials, if any. It is to be noted that in case the network sink 6 is communicating directly with the resource restricted-device 7 (that is without the need for the proxy node 1), the commissioning process remains the same but steps S201, S202, S203, S204 and S205 of the commissioning process of FIGS. 2A and 2B are not required. A simple state machine is running on the GPD, progressing to the next step (transmission of the next command in the handshake flow) only upon completion of the previous step (reception of particular command of the handshake flow).

It is important to note, that the GPD Commissioning command (message of step S203 of the 5-way handshake) is the same GPD Commissioning command, as used for unidirectional commissioning (they may obviously differ in the particular sub-fields, e.g. the key type requested/provided and the capability to open the reception window). The remaining messages of the 5-ways handshake are only implemented by the sinks capable of bidirectional commissioning.

The biggest advantage of the bidirectional commissioning process is the simplification and shortening of the channel finding process for the user. For example, even the moderately energy-restricted GPD could send the GPD Channel Request command (the first command of the 5-way handshake) on multiple channels following the same commissioning trigger (e.g. a button operation by a user, leading to harvesting the energy of button operation, or amount of energy harvested by other means, e.g. solar cell, exceeding a particular threshold).

As an example: it is assumed that the GPD is capable of operating on all of the 16 IEEE802.15.4 channels in the 2.4 GHz band. If the GPD is capable of sending on a set of 4 channels a request upon every commissioning trigger (e.g. a button operation by a user), then the user only needs 4 button operations to cover all the 16 channels (instead of the 16 button operations in case only one Channel Request command could be sent following each commissioning trigger).

The “energy rich” GPD could potentially be able to complete the entire commissioning following just a single commissioning trigger.

Also, since the feedback on the commissioning progress is given directly to the GPD, there is much less reliance on the perception and action of the user, which may not necessarily be timely, reliable or correct. Also, the response times of the network are much faster (in the range of few/tens of milliseconds), as compared to that of the user (usually in the range of seconds).

However, the biggest disadvantage of the bidirectional commissioning is its complexity and the resulting code size penalty. The proxy nodes which transparently forward the communication to the resource-restricted device must implement specifically for the bidirectional communication the gpTxQueue to buffer the messages, security code to protect the outgoing messages, and GP cluster messages (GP Response) to receive the frames from the network sinks.

The burden on the network sinks is yet higher: in addition to the gpTxQueue and outgoing message security, if they need to be able to communicate to the GPD in range, they need to implement the state machine complementary to that of the GPD, incl. generation of the relevant commands, a TempMaster election procedure, to determine one and only one sender for the message to the GPD, and generation of the GP Response command.

Thus, implementing bidirectional commissioning may be infeasible for some proxy nodes and network sinks, esp. those with limited code size memory, e.g. in embedded devices, like light bulbs.

As mentioned before, the resource-restricted device (here a GPD) using bidirectional communication uses a state machine. If the proper response is not received—and Channel Configuration command cannot be sent by a network sink incapable of bidirectional commissioning—the state machine will never advance and the commissioning will irreparably fail.

An automatic fallback to the unidirectional commissioning process is not feasible on the GPD. Firstly, the fallback method (likely unidirectional commissioning) requires the user to be involved (trigger each channel toggle operation until system feedback is available), since there is no other means for closing the feedback loop.

Secondly, the GPD has no means of determining the cause of the response lacking, as there could be many, ranging from in-network or external interference, devices not being operational yet (starting/booting/changing configuration), devices being out of range (e.g. due too big a physical distance), and—as in the case of interest for this invention—devices not being capable of performing the first commissioning process, in this example, the bidirectional commissioning).

Thirdly, given the usually sparse user interface means on the GPD, both for input and for output, switching the commissioning modes arbitrarily would likely put the GPD in a state unknown (or undesired to the user) and possibly hard to recover from.

The embodiments of the invention are aiming at solving these problems. In accordance with a first embodiment of the invention, the network sink, not capable of bidirectional commissioning, is able to recognize the first commissioning process being used and provide itself or trigger in the network a reliable feedback that the first commissioning process, e.g. bidirectional commissioning will fail. This failure can be the consequence of capability mismatch (e.g. the network sink 6 cannot handle the bidirectional commissioning or the proxy node 1 cannot handle the bidirectional commissioning). In another example, the first commissioning process cannot be supported because of the network conditions (channel quality issues linked for example to external or network internal interference, multipath fading or topology issues with nodes too far one from another, and thus too low signal strength or the like).

Based on this feedback given by the sink or the network, the user can then switch the commissioning mode on the resource-restricted device, falling back to a supported commissioning process. As illustrated on FIG. 1, the feedback can be a light setting of the luminaire driven by the network sink 6, e.g. flashing red status LED or flashing the luminaire controlled by the sink node. It can also or alternatively start a buzzer or another audible feedback. In yet another example, the network sink can start vibrating. In a further example, the network sink can display a message on a display, if available. In yet another example, the network sink 6 can also or alternatively trigger the feedback to be given by another network node for example in the vicinity of the resource-restricted device 7, for example by the luminaires driven respectively by network nodes 1 and 2, e.g. lamps capable of flashing/color changing/making sound or vibrating. To trigger the feedback by one or several devices closest to the GPD, the location can be derived by the network sink from the content of the proxy node (or Green Power Proxy, GPP) short address and GPP distance fields of the GP Commissioning Notification.

In addition, the feedback may utilize any rich user interface devices, e.g. commissioning tools, devices with displays, etc., to provide explicit and non-mistakable user feedback.

Thus, the user is prompted to cause the resource-restricted device to select another commissioning process, by for example pressing a combination of buttons or performing a press sequence on the resource-restricted device. Preferably, the commissioning process switching is done in such a way, that the other commissioning process is simplified for the user, i.e. preferably preserving at least some benefits from the fact of having started with the bidirectional commissioning process. In a particular embodiment that will be detailed in the following, as a result of the failed attempt with the first commissioning process, the resource-restricted device may nevertheless obtain some indication regarding the operational channel of the network.

In the various examples of the description, the network sink is mentioned as the (non-bidirectional-capable) device to be paired with a bidirectional-capable resource-restricted device. However, the solutions illustrated in the embodiments of this invention are also applicable to any other device that can be involved in commissioning of a resource-restricted device, e.g. a concentrator, a gateway, a commissioning tool, etc.

The solution is further applicable to facilitate fallback between for any other commissioning process selected by the resource-restricted device, incl. auto-commissioning, unidirectional commissioning, bidirectional commissioning, zone commissioning, tool-based commissioning, etc. Indeed, if the sink supports and prefers the bidirectional commissioning process (e.g. because the sink intends to provide the resource-restricted device with the shared security key, e.g. in order to reduce the memory requirements on the sink or if the sink intends to update the key initially used for protecting the key transfer over the air), the sink may use the current method to attempt triggering the fallback on the resource-restricted device from e.g. a unidirectional commissioning process to a bidirectional one, if supported. The user action to trigger the particular fallback may be different depending on the commissioning process currently used, or the same for any fallback action, thus effectively allowing for “toggling” though the commissioning processes until a commonly used one is found.

According to a first embodiment of the invention, in order to provide reliable feedback, the sink node not capable of bidirectional commissioning must first be able to recognize that the resource-restricted device to be paired actually attempts the first commissioning process, here the bidirectional commissioning process. In this first embodiment, this detection of the first commissioning process can be carried out by various methods. It can be determined whether the commissioning initiation message includes command identifier indicative of a channel request in accordance with the first commissioning process. For example, it is proposed to check the CommandID of the received GPD frame (independently if it was received directly from the GPD in radio range or forwarded by a proxy node). If the CommandID carries the identifier of the GPD Channel Request command (0xE3), i.e. the first command of the 5-way handshake of bidirectional commissioning, then instead of dropping it, as a sink not capable of bidirectional commissioning would do, the network sink recognizes that bidirectional commissioning is ongoing. It is to be noted that, if the GPD Channel request command is received directly from the GPD, the sink has to understand to search for the CommandID at the location in the frame defined by the Maintenance frame type, which is different from the Data frame type usually used; this minimum knowledge of the Maintenance frame type would be an additional requirement on the sink not capable of bidirectional commissioning, because the Maintenance frame type according to the current GP specification (page 219, line 5-10 of GP v1.0.1 specification draft, ZigBee document 14-0093r04) is used only for channel establishment as part of bidirectional commissioning. This method is most precise.

As an alternative, the network sink can also determine a frame type indicative of maintenance frame used by the resource-restricted device to initiate the first commissioning process. In this example, the network sink recognizes bidirectional commissioning by the usage of the Maintenance frame type of the GPD frame. If the command from the resource-restricted device is received directly from the resource-restricted device in radio range, the frame type sub-field is explicitly present in the NWK Frame Control field of the GPD frame. If the command from the resource-restricted device is received via a proxy node, then the usage of the Maintenance frame type is indicated by the GP_ID field of the GP Commissioning Notification command from the proxy carrying the value of 0x00000000 and the ApplicationID sub-field of the Options field carrying the value of 0b000. This method is equivalent to the method above in the current version of the GP specification (GP v1.0.1 draft, 14-0093r04).

In another variant of the invention, the network sink determines that a reception window indicator value, indicative of a reception window during which the resource-restricted device receiver is activated, is of a predetermined value. This applies if the network sink receives the message directly from the resource-restricted device (not via a proxy node). In the case ZigBee Green Power, the RxAfterTx sub-field of the Extended NWK Frame Control field of the GPD frame is set to Obi; only the Extended NWK Frame Control field is not present in the Maintenance frames used by GPD Channel Request command.

In case the network sink receives the initiation message from a proxy node, it can also determines that the first commissioning process has started by checking whether this initiation message carries a request for electing a proxy node for interfacing the resource-restricted device with the rest of the network. In the context of ZigBee Green Power, it means that the AppointTempMaster sub-field of the Options field of the GP Commissioning Notification command is set, and the Green Power Proxy (GPP) short address and GPP distance fields are present; the proxies will set the AppointTempMaster sub-field and include the Green Power Proxy (GPP) short address and GPP distance fields on reception of GPD Channel Request command in a Maintenance frame, despite the lack of the explicit RxAfterTx sub-field therein. This method is not so reliable, because it may also trigger for any frame using bidirectional communication, e.g. operational frame of another GPD capable of bidirectional communication that just happens to be sent at the time of commissioning the first GPD.

Once the sink determined that the resource-restricted device to be paired with uses bidirectional communication, the network sink can provide user-perceivable feedback, a “no bidirectional capability indication” as explained earlier.

According to this embodiment of the invention, the resource-restricted device supporting the first commissioning process, e.g. the bidirectional commissioning, is required to implement a fallback commissioning process not involving the full set of the same features (in the particular example of the bidirectional commissioning process, the fallback commissioning process shall not use the bidirectional communication, which is, as explained above, quite resource consuming for the sink. The resource-restricted device thus requires a trigger of this fallback commissioning process.

Preferably, the resource-restricted device implements the unidirectional commissioning as fallback commissioning process; this is due to the fact that the unidirectional commissioning process—due to the fact of using the GPD Commissioning command also used as a third message of the 5-way commissioning handshake of the bidirectional commissioning process—allows the resource-restricted device to for providing its securing capabilities and, if supported, the security key, and application functionality. The means to trigger the commissioning mode switching can be e.g. a dedicated button, slider, rotating knob, pinhole, setting of a DIP switch; another operation of user interaction means used for another purpose (e.g. of the button used to trigger the bidirectional commissioning), e.g. short vs. long press, pressing pattern (e.g. 2 vs. 3 presses), interaction combination (e.g. pressing two buttons at the same time, etc.). The selection of the fallback commissioning process may be semi-permanent, i.e. taking effect until explicitly reset by another user action, device reset, device decommissioning. It may be also temporary, e.g. only valid for the duration of the user action (e.g. as long as a button is pushed), or only valid until completion of this commissioning exchange. This enables to keep the first commissioning process, e.g. the bidirectional commissioning process as the preferred commissioning process, and used for the first commissioning attempt. Said semi-permanent fallback may be of particular relevance to resource-restricted devices with multiple endpoints, i.e. resource restricted devices with multiple instances of application functionality, e.g. a switch with more than one rocker or a sensor sensing multiple physical phenomena and/or the same physical phenomenon at different locations; with said semi-permanent fallback, the commissioning of the subsequent endpoints can benefit from the commissioning of the first endpoint, including usage of the operational channel and usage of the determined fallback commissioning process. Possibly, this requirement is only applicable to GPDs utilizing bidirectional commissioning as their default method.

Thus, in accordance with this first embodiment of the invention, the “no bidirectional capability indication” from the network sink or from network nodes, triggers the user to perform the commissioning process switching at the resource-restricted device. It is to be noted that the resource-restricted device is not involved in providing feedback to the user in accordance with this embodiment. The user is the one which can close the loop based on the feedback provided by any other node in the network and input some feedback to the resource-restricted device.

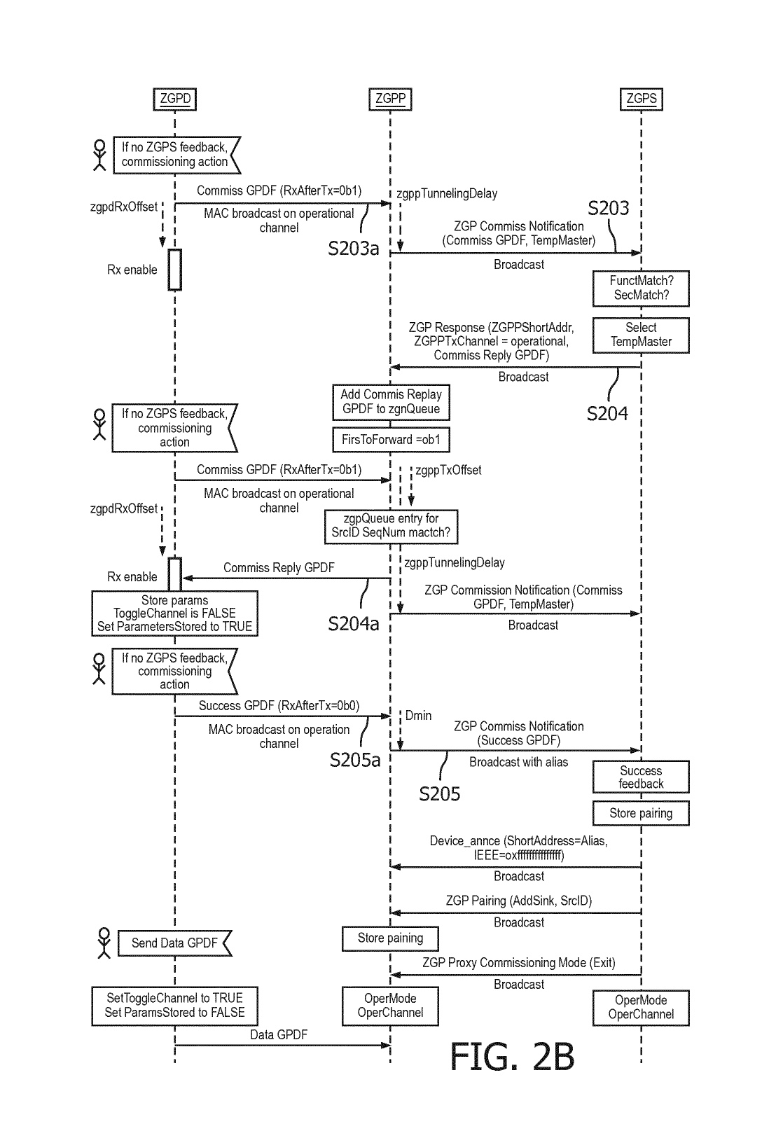

A method in accordance with an example of this first embodiment will now be illustrated with reference to FIG. 3. In this example, the resource-restricted device is a GPD capable of bidirectional commissioning in accordance with this embodiment of the invention. In this example, the resource-restricted device is capable of switching to unidirectional commissioning upon user action. The resource-restricted device is in this example energy-rich, i.e. the bidirectional commissioning is triggered by a single user action, although it could also be implemented on less energized resource-restricted devices requiring user action to continue with the commissioning process. In this example, the network sink is a GP sink which is not capable of bidirectional commissioning, but it is required to implement the current invention. The role of the sink can be performed by an actuator device to-be-controlled by the GPD, a GP-enabled concentrator device, a GP-enabled gateway device or a GP commissioning tool. The resource-restricted device is in radio range of the network sink, permanently or temporarily for the commissioning process, thus proxies may be used in the communication, however, they are not required in this example. Other devices, such as Trust Center, Commissioning Tool, network manager may be present and may, but is not required to, be involved in the method in accordance with this embodiment of the invention.

With reference to FIG. 3, this method is initiated at Step S301 when a user puts a non-bidirectional-capable sink into GP commissioning mode. This can be done, as seen previously, e.g. by using a local user action on the sink, e.g. pressing a button or a combination of buttons, or by an over-the-air message, e.g. the GP Sink Commissioning Mode command, or by any other application trigger. Upon another user trigger at step S302 at the resource-restricted device, the latter starts a bidirectional commissioning procedure. As seen previously with FIGS. 2A and 2B, the resource-restricted device starts to send GPD Channel Request commands using Maintenance GPD frame on different channels and enables a receive window after every Nth transmission, whereby N can be 1 and can vary, e.g. depending on the amount of energy available and the status of the procedure. If the GPD would receive a GPD Channel Configuration command (indicating bidirectional-capable sink is in the network), it would continue with bidirectional commissioning process.

Once the set of channels the resource-restricted device transmits on contains the operational channel of the network, the GPS receives the GPD Channel Request command from the resource-restricted device at step S303. The message is analysed by the GPS at step S304 such that the GPS detects that the bidirectional commissioning is being used. Since the GPS cannot support this bidirectional commissioning, the GPS triggers a user-perceivable “no bidirectional capability indication” at step S305. In this example, the sink can blink its own luminaire, with the color of the emitted light being red.

When the user sees the “no bidirectional capability indication” on the sink, the user performs the user action on the resource-restricted device to activate the fallback (to the unidirectional) commissioning process at step S306. Thus, the resource-restricted device is triggered to activate the fallback commissioning process. The resource-restricted device disables bidirectional commissioning and enables the fallback (unidirectional) commissioning process at step S307.

In order to complete the unidirectional commissioning process, the user starts the user action to perform the user-triggered channel toggling on the GPD (resulting in transmission of GPD Commissioning command), and checks for “commissioning success” feedback at step S308. This means that the user must repetitively perform the user action until a channel is found and the “commissioning success” feedback indicated that the commissioning is successful. From the GPS point of view, on the operational channel, the GPS receives the GPD Commissioning command and, if all relevant checks succeed, provides user-perceivable “commissioning success” feedback.

At step S309, based on the “commissioning success” feedback, user can refrain from further user-triggered channel toggling; commissioning of the resource-restricted device is now completed.

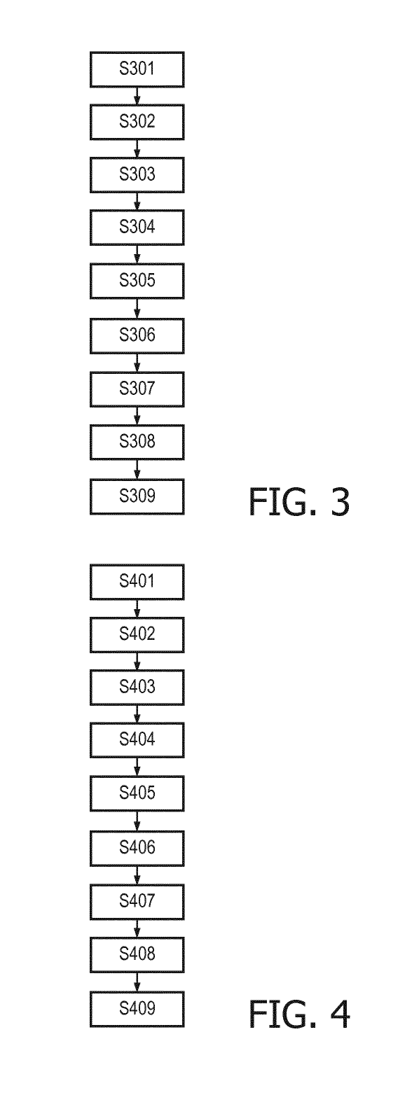

In accordance with a second embodiment illustrated on FIG. 4, the maximum advantage is taken from the attempted bidirectional commissioning; specifically, the information about the operational channel of the network is inherited by the fallback commissioning process from the first commissioning process. To achieve that, it can be preferred that the automatic channel toggling speed of the resource-restricted device, for example the “energy rich” GPD 9 of FIG. 1, corresponds to the expected user reaction times until activating the fallback commissioning process.

In this exemplary embodiment, the resource-restricted device is a GPD capable of bidirectional commissioning in accordance with the proposed aspects of the invention, i.e. capable of switching to unidirectional commissioning upon user action. The GPD is preferably energy-rich, i.e. the bidirectional commissioning is triggered by a single user action, although it could also be implemented on less energized resource-restricted devices requiring user action to continue with the commissioning process. The channel toggling speed matches the expected reaction time of the user. The network sink is a GP sink not capable of bidirectional commissioning extended according to the current aspects of the invention. As in the first embodiment, the resource-restricted device is in the radio range of the network sink, proxy nodes and other devices, such as TC, CT, network manager may or may not be involved.

In accordance with the method of the second embodiment, at step S401, the user puts a non-bidirectional-capable sink GPS into commissioning mode, and at step S402 the user triggers the GPD to start bidirectional commissioning procedure. In this embodiment, the GPD start to slowly explore the channels by sending GPD Channel Request on the different channels and enables a receive window after each transmission. Regarding the channel toggling speed, a new channel is transmitted on e.g. every 1-2 seconds, allowing for human reaction times. The exact channel toggling speed may be selected based on the target user type, target application, resource-restricted device type, type of actuation, complexity of the user interface on the GPD, type of network sink node, type of “no bidirectional capability indication” on the sink, etc. It should be noted that in this example one message is sent on each channel and a corresponding reception window is then opened after a predetermined time duration following this transmission. In a variant, the GPD can transmit on a plurality of channels before a single reception window for this set of channels.

If the GPD would receive a GPD Channel Configuration command (indicating bidirectional-capable sink is in the network), it would continue with bidirectional commissioning process.

Once the set of channels the resource-restricted device transmits on contains the operational channel of the network, the GPS receives the GPD Channel Request command from the resource-restricted device at step S403. The message is analysed by the GPS at step S404 such that the GPS detects that the bidirectional commissioning is being used. Since the GPS cannot support this bidirectional commissioning, the GPS triggers a user-perceivable “no bidirectional capability indication” at step S405. In this example, the sink can blink its own luminaire, with the color of the emitted light being red. Preferably, step S405, i.e. providing the “no bidirectional capability indication” feedback, follows soon after step S403 and S404, so that the user can perform step S405, i.e. activate the feedback on the resource-restricted device, before the device moves to another channel set, as described in step S402.

When the user sees the “no bidirectional capability indication” on the sink, the user performs the user action on the GPD to activate the fallback (to the unidirectional) commissioning process at step S406. Thus, the resource-restricted device is triggered to activate the fallback commissioning process. The resource-restricted device disables bidirectional commissioning, stores the last channel the GPD Channel Request was sent on (the one immediately preceding the trigger to activate fallback commissioning process) as the operational channel of the network, and enables the fallback (unidirectional) commissioning process at step S407. Thus, from the feedback action, the GPD can deduce on which channel the network is currently operating.

Thus, at step S408, the GPD transmits on the operational channel of the network a GPD Commissioning command without further user action required. There is no need for channel toggling here as the operational channel of the network has already been found in step S406.

At step S409, the GPS receives the GPD Commissioning command and, if all relevant checks succeed, provides user-perceivable “commissioning success” feedback; the commissioning of the resource-restricted device is thus completed.

In a variant of the second embodiment, the time between the automatic channel toggling transmissions can be reduced below the expected time required for user reaction. This allows for keeping the commissioning procedure shorter, especially if a sink capable of bidirectional commissioning process is being linked to the resource-restricted device. Typical examples would be to reduce the time durations between channel toggling to half or a quarter of the expected reaction time of the user. In the preceding example the expected reaction time of the user was considered to be around 2 seconds. Therefore, in this example, this means to have a channel toggle every half second or every second.

However, that would mean that the GPD would likely have moved away from the operational channel of the network by the time the user activates the fallback (to the unidirectional) commissioning process. To compensate for that, the GPD can still try to make the best possible use of the bidirectional commissioning procedure attempted. The GPD can make an educated guess on the operational channel. For example, if the automated toggling speed is one channel a second, and the expected user reaction time is 2 s, and the channel search order is { . . . , N, M, O, . . . }, then if the fallback trigger is received while the GPD is on channel O, the GPD should assume N is the operational channel of the network/the channel to preferably restart the search from in the fallback commissioning process.

Further, the GPD can reduce the channel set to be searched, since the operational channel of the network must have been among the channels the GPD toggled through so far. For example, if the channel search order is {A, E, J, O, B, C, D, F, G, H, I, J, K, L, M, N, P}, then if the fallback trigger is received while the GPD is on channel O, the GPD should assume the operational channel of the network is in the set {A, E, J, O}, and limit further search to those channels.

Besides, the GPD can change the order of channel search, i.e. after the fallback trigger the GPD can first search the channel most recently toggled through. For example, if the channel search order is {A, E, J, O, B, C, D, F, G, H, I, J, K, L, M, N, P}, then if the fallback trigger is received while the GPD is on channel O, the GPD could start the user-triggered toggling by going through the channels in the following order {O, J, E, A}. It is to be noted that these examples can be combined one with another, for example restarting the search in reverse order with a limited list of channels.

To accommodate for possible human error or slow reaction time, leading e.g. to failure in activating the fallback mechanism on the first feedback indication, while still allowing the user to benefit from simplified fallback commissioning process, in particular from simplified channel selection, the feedback can have characteristics indicative of the time that passed since the reception of the first message of the first commissioning process. E.g. the lamp can flash quickly for X ms after reception of the first message of the first commissioning process, and then more slowly, or change light color, or switch off X ms after reception of the first message of the first commissioning process. This changing feedback pattern can help focus the user's attention to trigger the fallback at the right time next time, while still allowing the fallback trigger to assist in the channel selection.

Further, it is to be noted that the user reaction time is an estimate based on an implementation of a resource-restricted device and can vary depending for example on the user interface or the kind of action (combination/sequence of presses) required by the resource-restricted device to trigger the fallback commissioning process selection.

In the examples of the second embodiment, the resource-restricted device is configured to transmit on the channels one by one, i.e. to have a reception window for each transmission on each channel of the list of channels. However, these examples could be adapted to transmit on a set of channels comprising a plurality of channels for a single reception window. For example, upon trigger of the user, the resource-restricted device could send 4 messages on a set of 4 different channels and await a reply on a single listening channel corresponding to the set of channels. In this case, the time instant at which the fallback commissioning process is selected can indicate to the resource-restricted device in which set of channels the operational channel belongs to. In case the time duration is selected to be of the order of magnitude of the expected user reaction time, e.g. 2 seconds, the resource-restricted device can derive that the operational channel belongs to the last set of channels transmitted on. In case the time duration is selected to be of half or a quarter of the order of magnitude of the expected user reaction time, e.g. 0.5 or 1 second, the resource-restricted device can derive that the operational channel belongs to a group of channels consisting of a plurality of sets of channels recently transmitted on, thus reducing the channels to be searched in the fallback commissioning process. Then, the other variants regarding the order, the educated guess can also apply to this variant of this embodiment. Furthermore if the time of transmission on the entire channel set is smaller compared to the reaction time of the user and if the commissioning fallback is being triggered while the GPD is transmitting for a set of channel, the resource-restricted device can safely assume the commissioning fallback was not triggered by transmission on the current set, and thus exclude this set from the further search using the fallback method.

In extension to the first embodiment and to the second embodiment described above, the GPD can change the automatic channel toggling speed over the time. For example, the first N sweeps (where N is at least 1) through the channels may be quick, in case bidirectional commissioning succeeds. If no commissioning response is received, the following sweeps could be slower, to accommodate possibly adverse conditions, e.g. busy medium, interference, low quality of the link to the infrastructure, or for non-bidirectional-capable sinks. In another example, the first sweep can be slow, to allow for user fallback with operational channel determination if bidirectional commissioning process is not supported, and in case a response according to the bidirectional commissioning process is received, to speed up the transmission of the remaining messages of the 5-way handshake.

In a third embodiment of the invention, it is proposed to adapt the method in accordance with this invention to very to moderately energy-restricted resource-restricted devices, as well as for any resource-restricted device for which user-triggered channel toggling is used instead of automated channel toggling.

In this case, the resource-restricted device involved is a GPD capable of bidirectional commissioning according to the current aspect of the invention, i.e. capable of switching to a fallback commissioning process, like the unidirectional commissioning upon user action. The GPD channel toggling is user-triggered. Again, in this case, the network sink is a GP sink not capable of bidirectional commissioning, extended according to the current aspects of the invention.

Similarly as in the previous embodiments, the proxies or other devices, such as Trust Center, Commissioning Tools, network manager may or may not be involved.

In this embodiment, the workflow is as follows:

1. User puts a non-bidirectional-capable sink GPS into commissioning mode.

2. User triggers GPD to send GPD Channel Request on a first set of channels (whereby the set can consist of one channel only and/or the set size can vary) and enable its receive window.

a. If the GPD would receive a GPD Channel Configuration command (indicating bidirectional-capable sink is in the network), it would continue with bidirectional commissioning process.

User repeats step 2 until “commissioning success” feedback is received or another system feedback is received.

Thus, as in the second embodiment, the time between transmissions on different channels should allow for user reaction time.

3. On the operational channel of the network, the GPS receives the GPD Channel Request command from the GPD.

4. Then, the GPS detects the bidirectional commissioning being used and provides the user-perceivable “no bidirectional capability indication”.

5. Seeing the “no bidirectional capability indication” on the sink, the user quickly performs the user action on the GPD to activate the fallback (to the unidirectional) commissioning process.

6. GPD is triggered to activate the fallback commissioning process. The GPD:

a. disables bidirectional commissioning process;

b. enables the fallback (unidirectional) commissioning process.

c. If the set of channels in step (2) consisted of one channel only: GDP stores the last channel the GPD Channel Request was sent on (the one immediately preceding the trigger to activate fallback commissioning process) as the operational channel of the network;

d. If the set of channels in step (2) consisted of more than one channel: GDP needs to search the last channel set transmitting GPD Commissioning command on one channel only for each user action (preferably the same as in step 2).

7. On the operational channel of the network, upon user trigger, the GPD transmits GPD Commissioning command.

8. On the operational channel, GPS receives the GPD Commissioning command and, if all relevant checks succeed, provides user-perceivable “commissioning success” feedback.

Some further variations are proposed in the following exemplary further improvements of the invention:

I. To further assist the user in performing the fallback, the action the user has to perform can be related to the feedback obtained, e.g. green indicator (success) may require the user to press a green GPD button (to close the commissioning process), while the red indicator (non-capability) may require the user to press the red GPD button. In another example, the feedback could indicate the exact pattern, e.g. three short presses quickly following one another.

II. The commissioning process of the GPD can be extended to always use the feedback of the system for the channel search, in order to arrive on the operational channel of the network with less than 16 user actions, and still being able to cover all 16 channels (performing binary search).
On first user trigger, the GPD can transmit the channel request on the first 8 of the 16 channels (whereby the order of channels can be determined by the GPD), and then open a reception window; the user will wait for system feedback.

If the operational channel is among the 8 channels, feedback A is given to the user, and user performs action A on the GPD.

If the operational channel is NOT among the 8 channels, feedback B (which could also be no feedback) is given to the user, and the user performs action B on the GPD (may be no action).
The GPD knows now if the operational channel is among the first 8 or the second 8 channels. Thus, on second user trigger, the GPD can repeat the exercise for the first 4 among the respective 8 channels
On third user trigger, the user can get down to two candidate channels.
Upon 4th user trigger, the user can directly send GPD Commissioning command.
if no success feedback is received after 4th user trigger, upon 5th user trigger the GPD sends GPD Commissioning command on the operational channel.
if no success feedback is received after 5th user trigger, the procedure can be restarted from the last user feedback confirming a reception of a frame by the GPD (e.g. to compensate for a frame being lost) or all the way from the top (e.g. to nullify any user errors).

III. The method of improvement (II) could still preferably be combined with the capability of doing full bidirectional commissioning as well. This can be for example accomplished by adding a step after transmitting on the first 8 of the 16 channels upon the first user trigger, the additional step including transmitting on the other 8 of the 16 channels, to give system the opportunity to receive on each channel.

Since the system can most likely transmit to the GPD only on the next reception window of this GPD, the system feedback provided to the user may be earlier than the transmission of the GPD Channel Configuration. Thus, to best support the user, the feedback provided by the system could consist of at least 3 signals: (i) Channel Request received, bidirectional communication supported—the user can continue with the current process/user actions (ii) Channel Request received, bidirectional communication not supported—fallback triggering required (iii) nothing received, bidirectional communication supported; resulting in the corresponding user action on the GPD.

The appropriate reactions of the GPD to each of the feedbacks were, respectively:

(i) Continue with the planned bidirectional channel set+reception window;

(ii) Search the first half of the current set; bidirectional (incl. reception window) does not need to be used, i.e. GPD may directly switch to GPD Commissioning command (unless other aspects like protection of the security key make it refrain from this)

(iii) Search the other set.

IV. To speed up the delivery of the operational network channel to the resource-restricted device and triggering the fallback, for example to help for step (i) of improvement (III), upon entering the commissioning mode, the sink—if capable of bidirectional commissioning—could pro-actively put the GPD Channel Configuration command containing the operational channel of the network into a transmit queue of at least one device. This is possible, because the Channel Configuration command, like the Channel Request command, is sent using GPD Maintenance frame type, i.e. does NOT contain the address of the GPD it is targeted to, and security is not used.

In a further extension, upon entering the commissioning mode, the sink supporting bidirectional commissioning can send GP Response command carrying GPD Channel Configuration command to a number of (proxy) devices, instructing each proxy device to go (for 5 s) to a particular (different per proxy) channel to deliver it. This way, the proxies can be waiting on multiple channels, speeding up the bidirectional procedure.

This method may require the sink to know the density/location of the proxies, to serve the GPD in best possible manner.

This could be also done by the sink not capable of bidirectional commissioning, but extended according to the embodiments of the current invention; the additional requirement on such a sink would be to be able to send GPD Channel Configuration command via at least one bidirectional-capable proxy.

V. In another improvement, the proxies could autonomously go to different network channels, to provide the “no bidirectional capability indication” asap, i.e. in the event the GPD transmits on one of the proxy-selected channels before it transmits on the operational channel of the network. The proxies can do that “just in case”, or based on the knowledge of the sink being not capable of bidirectional commissioning. This could be e.g. derived from the attributes supported by the sink.

Alternatively, the GP Proxy Commissioning Mode command, instructing the proxies to enter/exit commissioning mode, can be extended with indication if bidirectional mode is supported and/or desired.

In another variant, the GP Response command, providing the proxy with a message to be delivered to the resource-restricted device, can be extended with indication if bidirectional mode is supported and/or desired.

The fact of going to another channel and/or selection of the channel to go may be dependent on the channel used by the network. E.g. if the operational channel of the network is one of the primary channels (11, 15, 20, 25), it has a high probability of GPD addressing it soon, so no additional proxy action is required. If the operational channel is one of the secondary channels and/or one of the high channels, e.g. 23 or 24, it has lower probability of GPD addressing it soon, so additional proxy action may be advantageous.

VI. The proxies, if capable of bidirectional communication and aware of the fact that the sink is not capable of bidirectional communication, can send over the air a message indicative of no bidirectional capability of the network. The message can be a dedicated message. It can also be an additional flag in the Channel Configuration message; then fulfilling two purposes: putting GPD on the operational channel of the network, and instructing it to fallback to unidirectional commissioning.

Improvement (VI) can be beneficially combined with improvement (V).

Otherwise, the system should guarantee by some means, that only one proxy will transmit to the GPD on the next reception window, e.g. by random selection, by agreement protocol, e.g. triggered by reception of the GP Proxy Commissioning Mode.

In either case, to assure user is aware of the fallback and ready to perform the user actions, if any are required by the fallback commissioning process, user feedback in form of the “no bidirectional capability indication” can be given.

VII. In another improvement of method (V) or (VI) it is the sink not capable of bidirectional commissioning that is required to select one proxy for message delivery to the GPD. To reduce the requirements on the sink not implementing the bidirectional commissioning mode, the sink could choose the proxy at random or choose the first proxy capable of bidirectional communication to send the GP Commissioning Notification (instead of using the TempMaster selection), and send a simple GP cluster command instead of complete GP Response carrying GPD Channel Configuration. E.g., is a sink capable of bidirectional commissioning receives in commissioning mode via a proxy (i.e. in a GP Commissioning Notification message of the GreenPower cluster) a GPD (commissioning) command that the sink does not implement, the sink can respond with ZCL Default response command, carrying the appropriate Status field, e.g. FAILURE or UNSUP_GENERAL_COMMAND. The sink can send this message in broadcast, or preferably in unicast to the proxy(s) that forwarded the GP Commissioning Notification command, most favorably the sink will only send it to one of the proxies, preferably to first one to deliver the GP Commissioning Notification message to the sink and having the bidirectional commissioning capability. Based on said ZCL Default response, the proxy(s) could create and deliver to the GPD a Channel Configuration message, with the flag for indicating lack of bidirectional commissioning capability, as mentioned in extension (V).

The proxy would preferably still deliver Channel Configuration message with the operational channel of the network and the no-bidirectional indication, thus fulfilling the two purposes mentioned in (VI).

A couple of exemplary embodiments illustrating the solution using selected elements of improvement (IV)-(VII) will now be detailed.

The benefits of improvements (III)-(VII) is that if the GPD Channel Configuration can be delivered to the GPD over the air, then the GPD learns the operational channel of the network (without any limitations on GPD's automatic channel toggling speed), no further search is necessary.

Another advantage related to the previous benefits is that the user does not need to be involved in activating the fallback commissioning process. That is due to the fact, that the user is no longer required to close the loop for the user-triggered channel searching, since the operational channel of the network is now configured over the air. E.g. in case GPD Channel Configuration command is used—the channel is explicitly included in the message. In another example, in case a dedicated “no bidirectional commissioning” message or any generic NACK message not containing the indicator for the network operational channel is used, the channel can be derived from the time instant this feedback message is received; the network node (e.g. a proxy) generating the message should then—rather than sending using any next possible reception window of the resource-restricted device not on the operational channel of the network—send it when the reception window of the resource-restricted device is on the operational channel of the network. If the GPD Channel Configuration is extended with the flag for indicating lack of bidirectional commissioning capability, or the above-described dedicated or NACK message is used, the user does not need to be involved in switching the commissioning process either.

Thus, the entire commissioning process can happen automatically, and the user doesn't even have to be aware that the fallback happened; no user perceiveable feedback is required, no special user action for falback triggering on the resource-restricted device is required; the user can repeat the commissioning action on the resource restricted device until success feedback is received from the system.

In a fourth embodiment of the invention, the sink not capable of bidirectional commissioning is allowed to benefit from the of the proxies in the system capable of bidirectional commissioning, if any.

In this example, the resource-restricted device involved is a GPD capable of bidirectional commissioning according to the current aspect of the invention, i.e. capable of switching to a fallback commissioning process, like the unidirectional commissioning, upon user action. The GPD channel toggling is user-triggered. Again, in this case, the network sink is a GP sink not capable of bidirectional commissioning, extended according to the current aspects of the invention.

For this example, at least one proxy device having the bidirectional commissioning capability is required.

Similarly as in the previous embodiments, other devices, such as Trust Center, Commissioning Tools, network manager may or may not be involved.

The workflow in accordance with this fourth embodiment is as follows:

1. A user puts a non-bidirectional-capable sink GPS into commissioning mode. This leads the sink to send a GP Proxy Commissioning Mode (enter) command. Upon reception of the GP Proxy Commissioning Mode (enter) command, the proxies enter into commissioning mode.

2. The user performs a commissioning action on the GPD and repeats this action until success feedback is provided by the system.

3. Upon this user commissioning action, the GPD sends a GPD Channel Request on a first set of channels (whereby the set can consist of one channel only and/or the set size can vary) and enables its receive window. The sets of channels and receive window may change for every user commissioning action.

a. If the GPD would receive a GPD Channel Configuration command (indicating bidirectional-capable sink is in the network), it would continue with bidirectional commissioning process.

4. One or more proxies in radio range of GPD receive the GPD Channel Request, and schedule sending of GP Commissioning Notification carrying GPD Channel Request.

a. If the proxy has at least some bidirectional commissioning capabilities, the GP Commissioning Notification shall indicate that (by setting AppointTempMaster sub-field of the Options field of the GP Commissioning Notification command into TRUE, and including the GPP short address and GPP distance fields).

b. If the proxy does not have bidirectional commissioning capabilities (permanently, because the feature is not available or temporarily, e.g. due to the TxQueue being full), the GP Commissioning Notification shall indicate that (e.g. by setting AppointTempMaster sub-field of the Options field to 0b0; the sink will still be able to recognize the bidirectional commissioning because of the CommandID, i.e. GPD Channel Request command).

5. On the operational channel of the network, the GPS receives the GP Commissioning Notification carrying GPD Channel Request command from the GPD.

6. The GPS detects the bidirectional commissioning being used. If at least one proxy is capable of bidirectional communication, the sink responds to the first bidirectional-commissioning-capable proxy that sent the GP Commissioning Notification with ZCL Default Response with Status UNSUP_GENERAL_COMMAND in unicast to that proxy.

7. The proxy receives the ZCL Default Response with Status UNSUP_GENERAL_COMMAND and puts GPD Channel Configuration command with the operational channel of the network and with the flag for indicating lack of bidirectional commissioning capability into its gpTxQueue. The proxy may attempt to deliver the frame on receive window on a channel other than the operational channel of the network.

8. Upon reception of a GPD Channel Request command from the GPD, the proxy delivers the GPD Channel Configuration command with the flag for indicating lack of bidirectional commissioning capability that was stored in its buffer gpTxQueue.

9. Upon reception of the GPD Channel Configuration command, the GPD:

a. disables the bidirectional commissioning process;

b. enables the fallback (unidirectional) commissioning process.

c. GDP stores channel from the GPD Channel Configuration command as the operational channel of the network.

10. On the operational channel of the network, upon user trigger, the GPD transmits GPD Commissioning command with RxAfterTx=0b0.

11. The proxies forward the GPD Commissioning Command in the GP Commissioning Notification to the sink.

12. On the operational channel, GPS receives the GP Commissioning Notification carrying the GPD Commissioning command (with AppointTempMaster sub-field of the Options field set to 0b0) and, if all relevant checks succeed, provides user-perceivable “commissioning success” feedback.

In a fifth embodiment of the invention, the proxies are aware of the sink not being capable of bidirectional commissioning, and assist in commissioning the resource-restricted device.

The devices involved in this fifth embodiment are similar to those of the fourth embodiment.

The workflow of this fifth embodiment is as follows:

1. A user puts a non-bidirectional-capable sink GPS into commissioning mode, which causes the sink to send GP Proxy Commissioning Mode (enter) command, extended with indicator for “bidirectional commissioning support” set to FALSE. Upon reception of the GP Proxy Commissioning Mode (enter) command, the proxies enter into commissioning mode; due to the indicator for “bidirectional commissioning support” set to FALSE, the proxy is aware that the sink cannot or does not wish to use the bidirectional commissioning process.

Then, steps 2-3 are similar to the fourth embodiment.

4. One or more proxies in radio range of GPD receives the GPD Channel Request, and—if it has bidirectional commissioning capability—randomly decides if to put the GPD Channel Configuration command with the operational channel of the network and with the flag for indicating lack of bidirectional commissioning capability into its gpTxQueue, and on which channel (of the future reception windows indicated by the GPD in the GPD Channel Request command) to deliver it. The proxy may refrain from sending GP Commissioning Notification carrying GPD Channel Request command to the sink.

5. Upon reception of GPD Channel Request command (on the operational channel of the network or another channel corresponding to a GPD's reception window), a proxy delivers the GPD Channel Configuration command with the network operational channel and the flag for indicating lack of bidirectional commissioning capability that was stored in its buffer gpTxQueue.

6. Upon reception of GPD Channel Configuration command, the GPD:

a. disables the bidirectional commissioning process;

b. enables the fallback (unidirectional) commissioning process.

c. GDP stores channel from the GPD Channel Configuration command as the operational channel of the network.

Then, the remaining steps are similar to steps 10-12 of the fourth embodiment.

Having the sink indicating the bidirectional commissioning support in the GP Proxy Commissioning Mode command obviously allows the non-bidirectional-capable sink to inform the proxies right at the start of the commissioning process; a sink that is capable of bidirectional commissioning can use this indicator to dynamically enable/disable bidirectional commissioning process at the proxies, e.g. due to infavorable conditions (e.g. high interference).

If the proxies would learn about the sink inability to perform bidirectional commissioning process via other means (e.g. by reading out the gpsFuntionality attribute), the non-bidirectional capable sink would not have to be modified in any way, i.e. the solution variant would work also with legacy sinks, if commissioning resource-restricted devices modified according to the invention via the proxies modified according to the invention.

VIII. In accordance with a further improvement of the discussed embodiments, the “no bidirectional capability indication” feedback provided by the sink not capable of bidirectional commissioning may be indicative of the operational channel used by the network. E.g., if the sink has a display (or it provides the feedback on a display of a CT/smartphone), it can display the operational channel. Or it can blink the operational channel on a LED or a set of LEDs, etc. This can be of use for GPD with user means allowing for explicit channel selection, e.g. a bank of 4DIP switches, different user actuation means (e.g. different buttons or button combinations, or button actuation patterns), etc.

IX. Another variant includes that the sink can trigger the “no bidirectional capability indication” feedback if it is capable of bidirectional commissioning, but the communication with (and especially to) the GPD is too unreliable. The sink can see the communication to the GPD is unreliable if its messages are never delivered, and the GPD does not advance its state machine.

X. Another variant addresses the case when a commissioning tool is involved in commissioning of the resource-restricted device. The tool can be utilized in multiple ways, e.g. it can be used to put selected proxies and/or sinks in commissioning mode, or it can be used to perform full commissioning process with the resource-restricted device, and configuring the selected proxies and/or sinks with the corresponding Proxy and Sink Table entries. Because commissioning tool is a dedicated tool for the commissioning support, it will likely be able to support multiple commissioning methods, to guarantee interoperability. The commissioning tool can be aware that the sink not capable of bidirectional commissioning (and/or communication) is to be linked with a particular bidirectional-capable resource-restricted device, e.g. by reading the gpsFunctionality attribute of the sink. In such a case, when performing the commissioning with the resource-restricted device and if the resource-restricted device starts with bidirectional commissioning process, the commissioning tool can still trigger fallback to the unidirectional commissioning method; since the tool is capable of bidirectional commissioning, it can preferable trigger the fallback via an over-the-air feedback message, not requiring special actions on the resource-restricted device from the user. Such proactive fallback may be beneficial, to avoid problems resulting from bidirectional capability mismatch in operation, when the tool may not ba available, at hand or involved, e.g. for the case of commissioning of the resource-restricted device to another (not-capable) sink, for re-commissioning of the resource-restricted device, e.g. upon network parameter change, e.g. operational channel change, etc.

XI. The “no bidirectional capability indication” feedback provided by the network sink being currently commissioned to the resource-restricted device may—instead of triggering the fallback commissioning process on the resource-restricted device—trigger the user to attempt the first commissioning process between the same resource-restricted device and another sink of the group of sinks to be controlled by the resource-restricted device. This applies especially in the case that a pre-commissioned group of sinks is to be commissioned, in particular linked, to the resource-restricted device.

While the invention focuses on the use of the methods during commissioning, the methods can also be applied during operation, e.g. if the network changes its operational channel or if the user erroneously activates commissioning on the resource-restricted device.

The embodiments of this invention focus on extending the sinks non-capable of bidirectional commissioning process to support the commissioning fallback. Similar extensions may be proposed for the proxies not capable of bidirectional commissioning, to still forward the commissioning frame indicative of the bidirectional commissioning process being used or otherwise indicate, e.g. through a generic ZCL command, the use of bidirectional commissioning process, such that it can provide the feedback to trigger commissioning fallback; the proxies can also trigger commissioning fallback themselves.

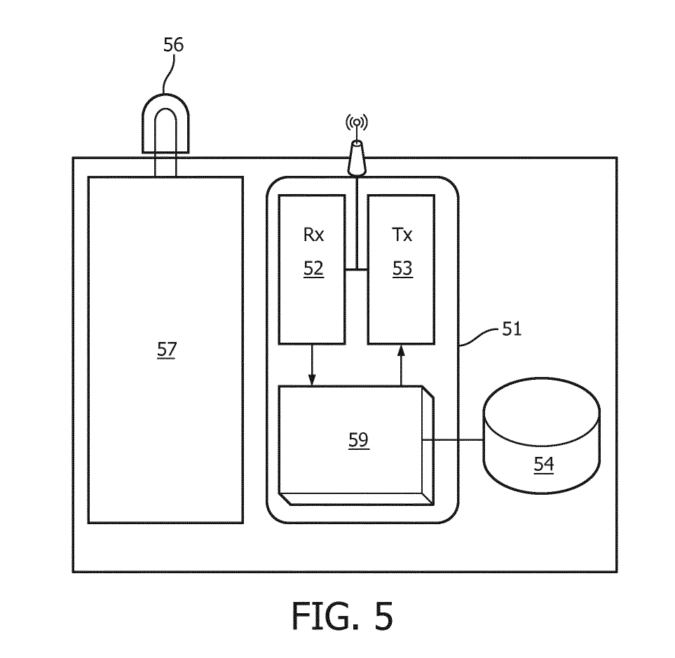

FIG. 5 represents a network sink in accordance with an embodiment of the invention. This network sink comprises a communication module 51 with a receiver 52 and a transmitter 53; the separation between the receiving and transmitting path can be physical, but also purely logical. When a network sink receives a message, for example a commissioning message from a resource-restricted device in order to link this resource-restricted device to the network sink, the receiver 52 decodes this message and pushes it to a microcontroller 59, for example a microcontroller of the communication module 51. In another variant of the invention, the microcontroller handling this message is the main microcontroller of the network sink. This microcontroller is arranged, for example by means of software, to determine from the commissioning message that a first commissioning process was initiated. As seen previously, this can be done by several ways, including detecting a frame format or a command identifier.

The microcontroller 59 is also able to determine if the first commissioning process can be supported, for example if the software code related to this first commissioning process is stored in a memory 54 of the sink and/or is directly programmed with the actions required because the first commissioning process is not supported. In case this first commissioning process cannot be supported, the network sink microcontroller 59 may trigger a feedback. This feedback may take the form of a command sent on the network by means of the transmitter 52, to request the actuation of an actuator connected to the network. This causes the user to select a fallback commissioning process at the resource-restricted device. In another example, the feedback takes the form of an internal command to a lamp driver unit 57 for switching on a luminaire 56. This feedback may further take the form of a command sent on the network by means of the transmitter 52, to inform a proxy capable of bidirectional commissioning about the sink's lack of this capability. This causes the proxy to transmit to the resource-restricted device a Channel Configuration command with the operational channel in the network and a flag for indicating lack of bidirectional commissioning capability, to trigger the commissioning fallback on the resource-restricted device.

Further, the network sink can comprise a user interface 57, for example a set of buttons that can be used for setting the network sink into commissioning mode, or LEDs or LCD screen to get some feedback regarding the operation or status of the sink.

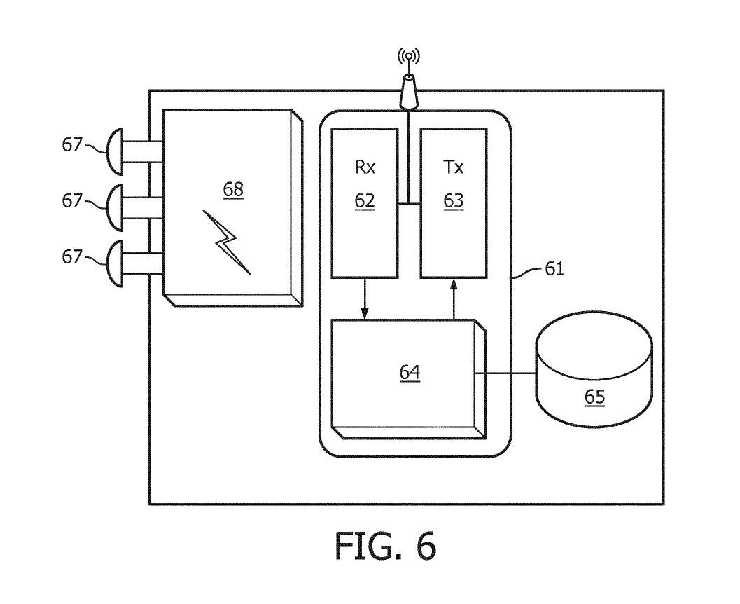

FIG. 6 represents a network device, for example a resource-restricted device in accordance with an embodiment of the invention.

The network device comprises a communication unit 61 including a receiver 62 and a transmitter 63. A microcontroller 64, for example included in the communication unit 61 is arranged to initiate a first commissioning process to be linked with a network sink. This commissioning process can be stored under the for of a software in a memory 65. This can be caused by the action of a user on a user interface 67, which typically includes a set of buttons, keys or rockers, whereby the buttons, keys or rockers used for the regular operation, e.g. triggering user control commands, e.g. on/off or level control, can be used for this purpose, e.g. after or in combination with a special commissioning trigger, such as pressing a contact in a pinhole, changing a setting of a dip switch, using a combination of buttons or using a particular sequence of button combinations, e.g. three short presses or one long press (e.g. of 10 s). In case this network device is a resource-restricted device, an energy harvester 68 can be included. This energy harvester 68 is for example a photocell harvesting the energy of the environment or a dynamo or magnetic coils coupled to actuators on the network device, thus harvesting the energy of the user operation.

The network device can control via its microcontroller 64 the transceiver 63 in order to transmit an initiation message in accordance with the first commissioning process on a set of channels comprising at least one channel of a sequence list of channels. Then, the microcontroller 64 sets the receiver 62 to remain in a receiving state for a receive window duration on a receiving channel. This receiving channel corresponds to the set of channels just searched (i.e. on which the transmitter has sent the initiation message). It is to be noted that in an example of the invention, there is only one channel per set of channels. There can be more, for example 4 or 8 depending on the network device abilities, esp. its energy budget.

At the expiration of the receive window duration, if no message according to the first commissioning process was received, the microcontroller awaits the expiration of a predetermined time duration to switch to the next set of channels for transmission on the at least one channel of the next set of channels and resume the search of the operational channel.

In accordance with this embodiment, the network device is arranged to have its microcontroller 64 (or another controller unit) to start a fallback commissioning process upon reception of a fallback trigger. This fallback trigger can be a feedback selection input from a user on the network device user interface 67 or a feedback message received at the receiver 62 from the network (the network sink or a proxy node). The microcontroller or the software stored on this network device is arranged to deduce an indication on the operational radio channel of the network from the time instant at which the fallback trigger is received for example as discussed in the previous embodiments of the invention; if the operational channel is not explicitly provided by the fallback trigger.

In particular, the network device can deduce an indication of the operational radio channel of the network from the time instant at which the feedback selection input is inputted by the user. In another example, the receiver 62 of the network device extracts an index indicative of the operational channel from the received feedback message. In another example, the receiver 62 of the network device can deduce an indication of the operational radio channel of the network from the time instant at which the feedback message is received, if the feedback message does not explicitly contain the index indicative of the operational channel.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

The foregoing description details certain embodiments of the invention. It will be appreciated, however, that no matter how detailed the foregoing appears in text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated.

1. A method for commissioning a resource-restricted device to a network, to link said resource-restricted device to a network sink,
the method comprising the steps of
receiving at the network sink a commissioning initiation message from the resource-restricted device for initiating a commissioning in accordance with a first commissioning process to link said resource-restricted device to the network sink,
if the first commissioning process cannot be supported by the network sink, the network sink triggering a feedback including actuation of an actuator connected to the network for prompting a user to select a fallback commissioning process via a commissioning process selection at the resource-restricted device.

2. The method of claim 1, wherein the step of the network sink triggering a feedback comprises at least one of the following:
causing at least one network node to switch on a luminaire with a predefined setting;
causing at least one network node to emit an acoustic signal or a vibration;
causing a graphic user interface of a network node to inform the user to select a fallback commissioning process.

3. The method of claim 1, wherein said network sink drives a sink actuator, and wherein the step of triggering a feedback includes actuation of said sink actuator in accordance with a predefined setting.

4. The method of claim 1, wherein the step of triggering a feedback comprises the step of selecting at least one node in the vicinity of the resource-restricted device and triggering the actuator of said selected node.

5. The method of claim 1, wherein the step of receiving a commissioning initiation message comprises detecting that the commissioning has been initiated by the resource-restricted device according to said first commissioning process, said detection including at least one of the following:
determining that the commissioning initiation message includes command identifier indicative of a channel request in accordance with the first commissioning process;
determining a frame type indicative of maintenance frame used by the resource-restricted device to initiate the first commissioning process;
determining that a reception window indicator value, indicative of a reception window during which the resource-restricted device receiver is activated, is of a predetermined value;
determining that the initiation message carries a request for electing a proxy node for interfacing the resource-restricted device with the rest of the network.

6. The method of claim 1, wherein the fallback commissioning process is selected by the network sink from a set of a plurality of commissioning processes, and wherein the feedback is indicative of the fallback commissioning process selected from the set.

7. The method of claim 1, wherein the feedback is indicative of the operational channel of the network.

8. A network sink adapted for operating in a network,
the network sink comprising a receiver adapted for receiving a commissioning message from a resource-restricted device in order to link said resource-restricted device to the network sink, the network sink being arranged to determine from the commissioning message that a first commissioning process was initiated,
the network sink being arranged to determine if the first commissioning process can be supported, and wherein the network sink is adapted to trigger a feedback including actuation of an actuator connected to the network for prompting a user to select a fallback commissioning process via a commissioning process selection at the resource-restricted device upon determination that the first commissioning process cannot be supported.

9. A method for commissioning a network device to a network sink in a network, comprising steps of
(a) the network device initiating a first commissioning process, wherein step (a) includes
the network device searching an operational channel of the network, whereby
the network device transmits an initiation message on a set of channels comprising at least one channel of a sequence list of channels, and
the network device remains in a receiving state for a receive window duration on a receiving channel corresponding to the set of channels before switching after a predetermined time duration to the next set of channels for transmission on the at least one channel of the next set of channels,
(b) receiving a fallback commissioning trigger requesting the network device to select a fallback commissioning process different from the first commissioning process, wherein the network device derives information on the operational radio channel of the network from the received fallback commissioning trigger.

10. The method of claim 9, wherein the step of the resource-restricted device deriving the operational channel includes at least one of
the network device deduces an indication of the operational radio channel of the network from the time instant at which the fallback trigger is received, and wherein the fallback commissioning trigger is a feedback selection input from a user;
the network device extracts an index indicative of the operational channel from the fallback commissioning trigger, which is a received feedback message;
the network device deduces information on the operational radio channel of the network from the time instant at which the fallback commissioning trigger, which is a feedback message is received.

11. The method of claim 9, wherein the time duration is of an order of magnitude being equal to an order of magnitude of a reaction time of a human being, wherein the resource-restricted device deduces from the time instant at which the user selects a fallback method that the operational radio channel of the network is included in the set of channels of the latest transmission.

12. The method of claim 9, wherein the time duration is of an order of magnitude being lower than an order of magnitude of a reaction time of a human being, wherein the resource-restricted device deduces from the time instant:
that the operational radio channel is included in a subset of channels of the sequence list, and the resource-restricted device starts the fallback commissioning process based on said subset of channels, wherein the subset of channels consists of at least one set of channels, or
a radio channel from the list, wherein the resource-restricted device resumes the channel search in the fallback commissioning process from said radio channel.

13. The method of claim 11, wherein the channel search is resumed in reverse order for the fallback commissioning process.

14. The method of claim 9, wherein the fallback commissioning process comprises the resource-restricted device changing the set size and/or the time duration depending on the feedback or the progress of the first commissioning process.

15. A network device for communicating in a network,
the network device being arranged to initiate a first commissioning process to be linked with a network sink,
the network device comprising a transceiver and the network device being arranged to control its transceiver for transmitting an initiation message in accordance with the first commissioning process on a set of channels comprising at least one channel of a sequence list of channels, and to remain in a receiving state for a receive window duration on a receiving channel corresponding to the set of channels before switching after a predetermined time duration to the next set of channels for transmission on the at least one channel of the next set of channels,
wherein the network device is arranged to start a fallback commissioning process upon reception of a fallback commissioning trigger, and wherein the network device deduces an indication of the operational radio channel of the network from the time instant at which the fallback commissioning trigger is received.
